(19) United States
(12) Patent Application Publication
(10) Pub. No.: US 2021/0272147 A1
(43) Pub. Date: Sep. 2, 2021

(54) METHOD AND SYSTEM FOR INTERACTING WITH AN ENTITY

(71) Applicant: sticky.io, Inc., Tampa, FL (US)

(72) Inventors: Brian A. BOGOSIAN, San Francisco, CA (US); Clark HUANG, St. Petersburg, FL (US); Justin SHOOLERY, San Francisco, CA (US)

(21) Appl. No.: 17/258,325

(22) PCT Filed: Jul. 6, 2018
(86) PCT No.: PCT/US2018/041089

§ 371 Date: Jan. 6, 2021

(51) Int. Cl. G06Q 30/02

(52) U.S. Cl. CPC G06Q 30/0211; G06Q 30/0224; G06Q 30/0239

(57) ABSTRACT

There is provided a method including receiving at an interaction engine an identifier associated with an entity from a set of entities, and obtaining a suitability score for the entity based on the identifier. The method also includes receiving at the interaction engine a selection of an objective associated with the suitability score, and receiving a respective selection of a suitability tolerance associated with the objective. The suitability tolerance can be further associated with a suitability score range. Moreover, the method includes generating at the interaction engine an acceptability indicator by determining whether the suitability score falls within the suitability score range, and outputting the acceptability indicator.

### FIELD

The present specification relates to methods and systems for interacting with an entity, and in particular to methods and systems for interacting with an entity over a communication network.

### BACKGROUND

Large communication networks can connect large numbers of entities. These networks can allow for digital or electronic communications. The network-connected entities can communicate and interact with other network-connected entities over the communication networks.

### SUMMARY

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” can be construed as X only, Y only, Z only, or any combination of two or more items X, Y, and Z (e.g., XYZ, XY, YZ, ZZ, and the like). Similar logic can be applied for two or more items in any occurrence of “at least one . . . ” and “one or more . . . ” language.

According to an aspect of the present specification there is provided a method comprising: receiving at an interaction engine an identifier associated with an entity from a set of entities; obtaining at the interaction engine a suitability score for the entity based on the identifier; receiving at the interaction engine a selection of an objective, the objective associated with the suitability score; receiving at the interaction engine a respective selection of a suitability tolerance associated with the objective, the suitability tolerance further associated with a suitability score range; generating at the interaction engine an acceptability indicator by determining whether the suitability score falls within the suitability score range, the acceptability indicator to indicate whether an interaction is to be attempted with the entity over a communication network; and outputting the acceptability indicator.

The interaction can comprise a transaction.

The obtaining the suitability score can comprise generating the suitability score based on past behavior of the entity.

The obtaining the suitability score can comprise predicting the suitability score based on one or more of past behavior of the entity and other information.

The other information can comprise a payment card type of the entity.

The obtaining the suitability score can comprise calculating the suitability score based on a formula selected based on the objective.

The objective can comprise one of increasing customer lifetime value, reducing chargebacks, reducing refunds, and reducing in-trial cancellations.

The suitability tolerance can comprise one of low, medium, and high, corresponding to respective suitability score ranges.

The method can further comprise: obtaining at the interaction engine a further suitability score for a further entity from the set of entities; and generating at the interaction engine a further acceptability indicator, the further acceptability indicator being positive regardless of whether the further suitability score falls within the suitability score range.

The method can further comprise: obtaining at the interaction engine a reattempt schedule for reattempting the interaction with the entity; and reattempting the interaction with the entity according to the reattempt schedule if the interaction has not been previously successfully attempted with the entity.

The interaction can comprise processing a transaction.

The method can further comprise: obtaining at the interaction engine a discount indication; and wherein the reattempting comprises attempting to process the transaction discounted according to the discount indication.

The reattempt schedule can comprise one or more of: frequency, date, time of day, time zone, and day of the week.

The method can further comprise: obtaining at the interaction engine an indication of a target number of reattempts of the interaction; determining at the interaction engine a reattempt number by tracking the number of reattempts; and reattempting the interaction if the reattempt number is less than the target number of reattempts and the interaction has not been previously successfully attempted with the entity.

The method can further comprise: obtaining at the interaction engine an indication of a target attempt age; determining at the interaction engine an age of a prior attempt of the interaction; and reattempting the interaction if the age is less than the target attempt age and the interaction has not been previously successfully attempted with the entity.

According to another aspect of the present specification there is provided a system comprising: a memory to store an identifier associated with an entity from a set of entities; an interaction engine in communication with the memory, the interaction engine comprising a processor to: receive the identifier; obtain a suitability score for the entity based on the identifier; receive a selection of an objective, the objective associated with the suitability score; receive a respective selection of a suitability tolerance associated with the objective, the suitability tolerance further associated with a suitability score range; generate an acceptability indicator by determining whether the suitability score falls within the suitability score range, the acceptability indicator configured to indicate whether an interaction is to be attempted with the entity over a communication network; and output the acceptability indicator.

The interaction can comprise a transaction.

To obtain the suitability score the processor can generate the suitability score based on past behavior of the entity.

To obtain the suitability score the processor can predict the suitability score based on one or more of past behavior of the entity and other information.

The other information can comprise a payment card type of the entity.

The processor can further calculate the suitability score based on a formula selected based on the objective.

The objective can comprise one of increasing customer lifetime value, reducing chargebacks, reducing refunds, and reducing in-trial cancellations.

The suitability tolerance can comprise one of low, medium, and high, corresponding to respective suitability score ranges.

The processor can further: obtain a further suitability score for a further entity from the set of entities; and generate a further acceptability indicator, the further acceptability indicator being positive regardless of whether the further suitability score falls within the suitability score range.

The processor can further: obtain a reattempt schedule for reattempting the interaction with the entity; and reattempt the interaction with the entity according to the reattempt schedule if the interaction has not been previously successfully attempted with the entity.

The interaction can comprise processing a transaction.

The processor can further: obtain a discount indication; and wherein to reattempt the interaction the processor can attempt to process the transaction discounted according to the discount indication.

The reattempt schedule can comprise one or more of: frequency, date, time of day, time zone, and day of the week.

The processor can further: obtain an indication of a target number of reattempts of the interaction; determine the reattempt number by tracking the number of reattempts; and reattempt the interaction if the reattempt number is less than the target number of reattempts and the interaction with the entity has not been previously successfully attempted.

The processor can further: obtain an indication of a target attempt age; determine an age of a prior attempt of the interaction; and reattempt the interaction if the age is less than the target attempt age and the interaction with the entity has not been previously successfully attempted.

According to another aspect of the present specification there is provided a non-transitory computer-readable storage medium comprising instructions executable by a computing engine, the instructions to cause the computing engine to carry out any one the methods described herein.

According to another aspect of the present specification there is provided a computer program comprising a program code for execution of all method steps according to any one the methods described herein, if the computer program is one or more of loaded in a computing engine and executed by a computing engine.

### BRIEF DESCRIPTION OF THE DRAWINGS

Some examples of the present specification will now be described, with reference to the attached Figures, wherein:

FIG. 1 shows an example scheme for source entities to interact with target entities through a communication network.

FIG. 2 shows a flowchart of an example method that may be used to assess the suitability of a target entity for interacting with a source entity.

FIG. 3 shows a block diagram of an example computing system.

FIG. 4 shows a block diagram of an example computer-readable storage medium.

### DETAILED DESCRIPTION

The size, reach, and information-carrying capacity of communication networks such as the Internet is increasing. In addition, an increasing number of entities are connecting to such networks. For example, these entities can include network-connectable devices or systems which can connect to networks to form connected systems such as the Internet-of-Things (IoT). In other examples, these entities can include sellers and buyers of goods and services who connect over communication networks.

As the number of the network-connected entities increases, and as the complexity and geographical expanse of the communication networks allows the connected entities to be remote from and at least partially unknown to one another, a source entity attempting to communicate with a target entity over a communication network may have imperfect information regarding the qualities, capabilities, or suitability of the target entity.

For example, a source device attempting to interact with a target device within an IoT scheme may have imperfect information about the qualities or operational standards of the target device. Similarly, a seller attempting to transact with a buyer over a communication network such as the Internet may not have intimate or complete knowledge of the buyer's suitability as a customer.

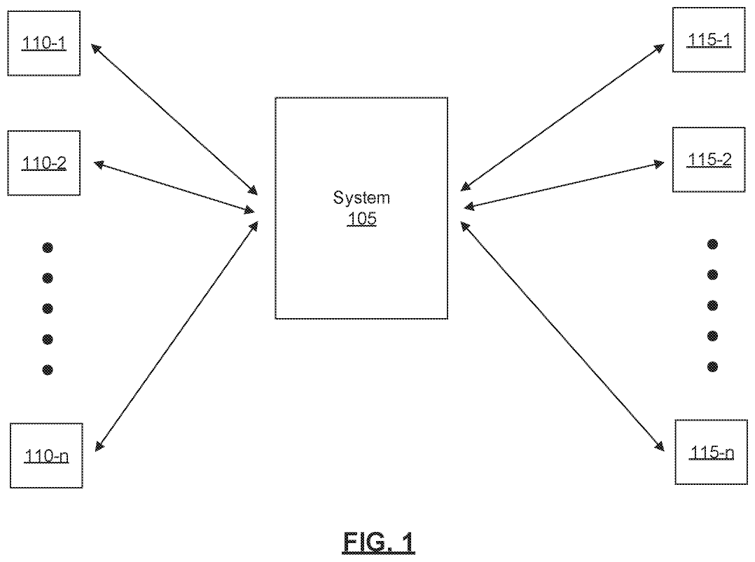

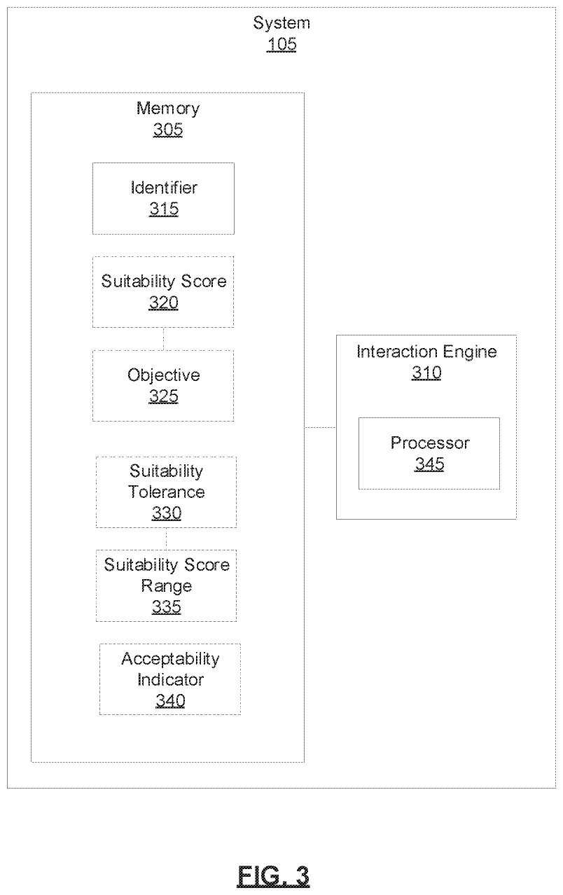

FIG. 1 shows a system 105, comprising an interaction engine (not shown in FIG. 1, but shown in FIG. 3), which can act as an intermediary between source entities 110-1, 110-2 to 110-n (generically or collectively referred to as source entities 110) and target entities 115-1, 115-2 to 115-n (generically or collectively referred to as target entities 115). System 105 can also be described as a system, platform, or tool that can be used by source entities 110 to communicate over communication networks with target entities 115. System 105 can allow source entities 110 to assess the qualities and/or suitability of target entities 115 for an interaction over a communication network. Moreover, in some examples system 105 can be used to reduce the likelihood of an attempted interaction between a source and a target entity being unsuccessful. Furthermore, in some examples system 105 can be used to allow for reattempting unsuccessful interactions to increase the likelihood of achieving a successful interaction.

While FIG. 1 shows multiple source entities 110 and multiple target entities 115, it is contemplated that in some examples there can be one source entity 110 and multiple target entities 115, multiple source entities 110 and one target entity 115, or one source entity 110 and one target entity 115. Source entities 110, system 105, and target entities 115 can be in communication over one or more communication networks. In some examples, these communication networks can comprise digital and/or electronic communication networks. Furthermore, in some examples, these networks can comprise a wired, a wireless, or a combined wired and wireless network. In some examples, the communication networks can comprise the Internet, a cellular network, a Wi-Fi network, a local area network, a wide area network, a payment system network, and the like.

In addition, in some examples there may be intermediaries between source entities 110 and system 105, and/or between system 105 and target entities 115. For example, these intermediaries can include network providers and/or operators such as Internet Service Providers, payment processors or payment systems providers such as payment gateways, filters, network switches, firewalls, and the like. In some examples, in addition to communicating with target entities 115 using system 105, source entities may have additional direct communication links with target entities 115.

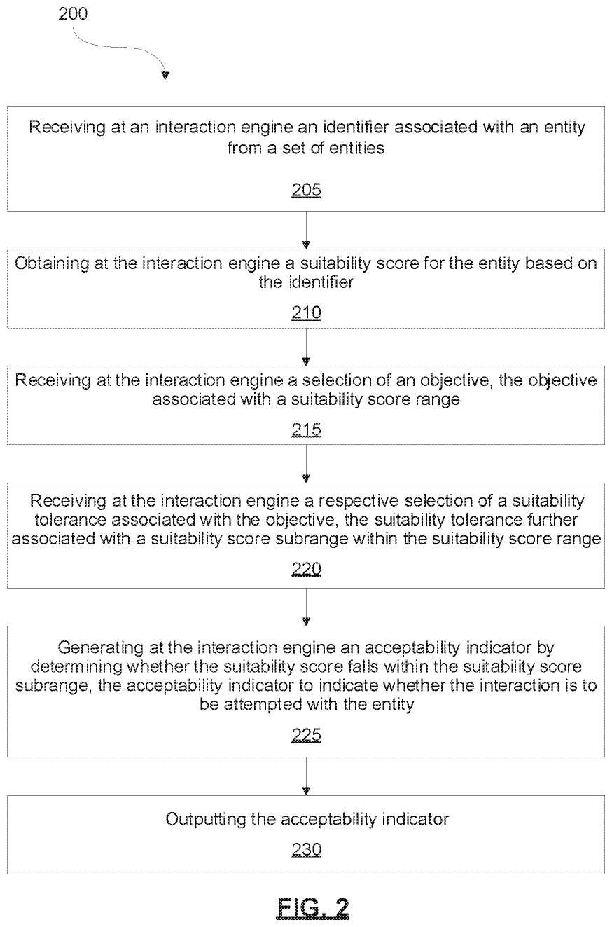

Turning now to FIG. 2, a flowchart is shown of an example method 200 that may be used to assess the suitability of a target entity for interacting with a source entity. At box 205 an identifier associated with an entity can be received at an interaction engine. In some examples, the entity can comprise a target entity from a set of target entities. The set of entities can comprise one entity or a plurality of entities. As discussed above, the target entity can comprise a device or a system. In some examples, the target entity can comprise a buyer, a buyer's device, or a buyer's user's terminal. The buyer can comprise a device, a system, a human, an artificial-intelligence digital assistant, and the like.

The identifier can comprise a string of letters, numbers, and/or symbols that that can identify the entity. In some examples, the identifier can uniquely identify the entity. Moreover, in some examples the identifier can comprise a serial number, an IP address, a user credential, an email address, or the like. The identifier can be received from the entity, from the source entity, or from a third-party device, repository, database, or other sources.

At box 210, a suitability score for the entity can be obtained at the interaction engine. The suitability score can be based on the identifier. The suitability score can provide a measure or indication of the suitability of the entity for interacting with the source entity. The score can comprise a number, a letter indicator, a designation, a classification, and the like. In some examples, the suitability score can be retrieved from a repository or database that stores suitability scores in association with corresponding identifiers for various entities. In other examples, the interaction engine can generate or calculate the suitability score.

At box 215, a selection of an objective can be received at the interaction engine. The objective can be associated with the suitability score. The objective can be received from the source entity, from a third party, or the like. The objective can reflect an aspect, quality, or target outcome of the interaction that the source entity is intending to attempt with the target entity. For example, in a case where the source entity is a digital personal assistant intending to summon or hire a self-driving car as the target entity, the objective may reflect a target safety level or timeliness of service. In other examples, where the source entity is a seller intending to enter into a transaction with a buyer as the target entity, the objective may comprise maintaining a target level of returns or refunds.

The objective and the suitability score may be associated with one another. For example, depending on the objective, the suitability score may be calculated or generated in different ways or according to different formulae. Such a formula can be selected based on the objective. As an example, the scoring system or scale used to assess the timeliness of a self-driving car service may be different than the scoring system or scale used to assess the likelihood of a transaction leading to a return or a refund.

At box 220, a selection of a suitability tolerance can be received at the interaction engine. The suitability tolerance can be associated with the objective. Furthermore, the suitability tolerance can be associated with a suitability score range. The suitability tolerance can comprise a selection or range of suitability scores. As such, the suitability tolerance can reflect a target degree of conformity with the chosen objective. For example, if the objective relates to the timeliness of self-driving car services and the scoring system assigns higher scores to more timely services, the suitability tolerance can indicate that entities with suitability scores in the top twenty-five percentile of scores are acceptable. The top twenty-five percentile can represent the suitability score range indicated by the suitability tolerance. In some examples, the suitability tolerance can comprise one of low, medium, and high, corresponding to respective suitability score ranges.

The selection of the suitability tolerance can be received from the source entity, a third party, or the like. Moreover, at box 225 an acceptability indicator can be generated at the interaction engine by determining whether the suitability score falls within the suitability score range. The acceptability indicator can indicate whether or not an interaction is to be attempted with the entity. The interaction can take place over a communication network.

In some examples, the acceptability indicator can comprise two states or values: positive or negative. A positive value can indicate that the source entity can attempt the interaction with the target entity. A negative value, in turn, can indicate that the source entity should not or cannot attempt the interaction with the target entity. In other words, positive acceptability indicator can indicate that the target entity is acceptable for interaction with the source entity, whereas a negative acceptability indicator can indicate the opposite. In some examples, the acceptability indicator can comprise further states in addition to the positive and negative states. Examples of such further states can include a conditional positive, conditional negative, hold, reevaluate later, no decision, and the like.

At box 230, the acceptability indicator can be output. To output the acceptability indicator, the acceptability indicator can be stored in a memory, sent to an output terminal, communicated to another component or to another system, or the like. While some of the functions associated with method 200 are described as being performed by the interaction engine, it is contemplated that in some examples some of the functions can be performed by components or modules other than the interaction engine.

The interaction engine can comprise a computational or processing module capable of performing the functions described in relation to method 200 and the other methods described herein. In some examples, the methods described herein can be used in the context of sellers interacting with potential and actual buyers over communication networks such as the Internet and the like. In such an example, the source entity can be the seller, the target entity can be the buyer, and the interaction can be the transaction between the seller and the buyer.

Moreover, in some examples system 105 and the methods described herein can be used by sellers to manage trial-based, subscription-based, or recurrent billing sales campaigns. In such examples, the seller may initiate an online, electronic commerce, and/or mobile commerce sales campaign and use system 105 to manage the interaction with the potential and actual buyers. As the campaign can attract a large number of remote and/or imperfectly-known buyers, the seller can use the systems and methods described herein to assess the acceptability of the potential buyers.

In the context of such an example, at box 205 the interaction engine can receive an email address or other identifier of a potential buyer. At box 210, the interaction engine can obtain a suitability score for the buyer associated with the received email address. At box 215, the interaction engine can receive a selection from the seller of an objective. The objective can comprise increasing customer lifetime value, reducing chargebacks, reducing refunds, reducing in-trial cancellations, and the like. Based on the objective, the interaction engine can select the formula used to calculate the suitability score.

In some examples the suitability score can be calculated based on the past behavior of the buyer and/or other information. The past behaviors can comprise individual measures such as a record of the buyer's past refunds, in-trial cancellations, chargebacks, and the like. In some examples, these measures can comprise a count of the buyer's past refunds, in-trial cancellations, chargebacks, and the like. The system can maintain a repository or database of individual measures for multiple buyers.

For a given objective, an empirical equation or correlation can be derived from the individual measures data to express outcomes related to the given objective as a function of the individual measures. For example, such an empirical equation can be obtained by applying techniques such as logical regression and the like, to the record of individual measures for multiple buyers. Once the identity of the buyer becomes known and the buyer's individual measures can be obtained, the empirical equation can be used to calculate a score or probability of a given outcome related to the given objective. For example, once it is known that the buyer is John Smith and the objective relates to reducing refunds, the record of John Smith's individual measures (i.e. his past refund requests) can be plugged into the empirical equation to obtain a suitability score reflecting the probability of John Smith seeking a refund in the future.

The suitability score can be scaled or normalized as a percentage, a number from one to one hundred, and the like. As the empirical equation is derived for a given objective, the equation and also the suitability score can change based on the objective.

In addition to past behavior and/or individual measures, other information can also be used to calculate the suitability score. Such other information can comprise information about the buyer's payment source such as the buyer's payment card such as credit card. For example, credit cards can be grouped by bank identification number (BIN). Such BIN can comprise the first four or six digits of a payment card number. The BIN can provide information about the type of payment card, such as prepaid card, rewards card, platinum card, and the like. In some examples, the other information can comprise collective measures such as a measure of refunds, in-trial cancellations, chargebacks, and the like per BIN. These measures can comprise a count, a percentage, or a total value of refunds, in-trial cancellations, chargebacks, and the like.

The collective measures can be used to derive an empirical equation or formula, in a manner similar that described in relation to individual measures. In some examples, an empirical equation or formula can be derived that expresses the suitability score as a function of both individual measures and collective measures such as BIN-related measures.

In some examples, additional measures can be used to derive the empirical formula. These additional measures can comprise IP address, time of day of transaction, affiliate network the traffic/buyer came from, search engine campaign identifiers, product category, seller's vertical/industry, fraud scores from third-party providers, and the like. Other methods such as machine learning, statistical, and/or probabilistic models can be used to generate suitability scores based on the individual, collective, and/or additional measures. In some examples, these models can be implemented using a support vector machine, a genetic program, a Kohonen type self-organizing map, a hierarchical Bayesian cluster, a Bayesian network, a Naïve Bayes classifier, a support vector machine, a conditional random field, a hidden markov model, a k-nearest neighbor model, a multiple voting model, and the like. These models can be trained on collections of past individual, collective, and additional measures to enable them to generate suitability scores.

In addition, for a given buyer various measures can change from one transaction to another. For example, as time passes, the cumulative history of the buyer's past behavior can change. In addition, the payment card used, and therefore the BIN, can change between transactions. Moreover, additional measures such IP address, time of day of transaction, affiliate network, and the like can also change between transactions. As such, the suitability score for a given buyer can also change from one transaction to another. In other words, the suitability score can be transaction-specific and/or a function of the given transaction the buyer is seeking to undertake.

Turning now to box 220, the interaction engine can receive from the seller a selection of a suitability tolerance. This selection can indicate the range of suitability scores that are acceptable for the seller for the given objective. For example, if the suitability score represents the probability of the buyer seeking a refund, then a suitability tolerance selection of “high” can indicate that the seller is willing undertake transactions whose suitability score (i.e., probability of refund) is below 50%. If, on the other hand, the seller selects a suitability tolerance of “low”, the seller can be indicating that transactions whose suitability score (i.e., probability of refund) is below 10% are acceptable.

At box 225, the interaction engine can generate an acceptability indicator by determining whether the suitability score falls within the score range indicated by the suitability tolerance. For example, if suitability tolerance is selected to be “high”, indicating that the seller is willing undertake transactions whose suitability score (e.g. probability refund) is below 50%, and the probability of refund is calculated to be 40%, the interaction engine can generate an acceptability indicator that is positive, indicating that the buyers is suitable for interaction with the seller. Then, at box 230, the acceptability indicator can be output by, for example, making it available to the seller, buyer, or other components of system 105. The acceptability indicator can also be stored in memory, and used in generating or evaluating subsequent suitability score calculations for other transactions.

In some examples, a whitelist of identifiers can be maintained and the interaction engine can have access to the whitelist. The entities identified by the whitelist can be allowed to interact with the seller without being subject to acceptability assessment by the interaction engine as described in method 200 and the other methods described herein.

Moreover, in some examples the interaction engine can assign some target entities to a control group whose members are allowed to interact with the source entity either without being assessed by the interaction engine for acceptability or regardless of the acceptability indicator generated by the interaction engine. In some examples, these target entities can be chosen at random. Moreover, interacting with these target entities of the control group can allow system 105 to build its record of past individual, collective, and additional measures. Moreover, the control group can provide a baseline for assessing the effectiveness of method 200 and the other methods described above in achieving the objective.

In one example, the control group can be implemented by obtaining at the interaction engine a further suitability score for a further entity from the set of entities. Then, a further acceptability indicator can be generated at the interaction engine. This further acceptability indicator can be set to be positive regardless of whether the further suitability score falls within the suitability score range. In this manner, the further entity can be assigned to the control group. The same steps can be repeated to add additional members to the control group.

In the context of transactions between sellers and buyers, the buyers/transactions selected as part of the control group can either be exempt from acceptability assessment by the interaction engine, can receive a positive acceptability indicator, or can be completed regardless of the acceptability indicator.

In some examples, once a decision is made that a source entity will attempt to interact with a target entity, the attempt at the interaction may be unsuccessful. The interaction engine can then reattempt the interaction in an effort to successfully complete the interaction. The steps and functions performed in relation to reattempting can form a separate method or can be an addition to the steps and/or functionalities of method 200.

In some examples, a reattempt schedule for reattempting the interaction with the entity can be obtained at the interaction engine. Then, the interaction with the entity can be reattempted according to the reattempt schedule if the interaction has not been previously successfully attempted with the entity. To obtain the reattempt schedule, the interaction engine can retrieve the schedule from memory or can receive the schedule from the source entity or a third party.

The reattempt schedule can specify one or more of frequency, date, time of day, time zone, day of the week, and the like. The frequency can provide the number of days between successive reattempts. The date can provide the specific dates on which the interaction is to be reattempted. Moreover, the time of day can specify the specific time and indicate that the reattempt should take place at, before, or after the specified time. Time zone can further specify what time zone should be used to implement the time of day or other time or date details of the schedule. Day of the week can provide that the reattempts should take place on a specific day of the week. In some examples the reattempt schedule can also specify the day of the month, such as the first Monday of the month, and the like. These date, day, and time details can be used to align the reattempt schedule with external factors that may affect the success of the interaction such as opening or operating hours of an entity, pay dates of buyers, and the like.

For example, when the interaction comprises processing a transaction, the reattempt schedule may specify the opening hours of a bank responsible for processing the payment, to increase the likelihood of the transaction being reattempted when the bank is open and able to successfully process the transaction. Similarly, in an IoT context, the reattempt schedule can be selected to avoid planned maintenance or downtime periods, or to avoid peak demand times, for target entities. This in turn can be used to increase the likelihood of the reattempt of the interaction being successful.

In some examples where the interaction being reattempted comprises processing a transaction, the interaction engine can obtain a discount indication, and the reattempting can comprise attempting to process the transaction discounted according to the discount indication. The interaction engine need not itself be processing the transaction. In cases where a discount indication is received, the interaction engine can request, direct, or otherwise cause the transaction to be reattempted at a discount.

In examples where the transaction is related do a sale of goods that involves shipping costs, the discount can be selected to apply or not apply to the shipping costs. Moreover, in some examples a minimum transaction amount can be set below which either the transaction is not reattempted at all, or a discount does not apply to the reattempts. In some examples a minimum amount can be set to indicate that the transaction amount is not be discounted to fall below the minimum. Moreover, in some examples the discount can comprise a fixed amount for every reattempt, such as a $10 reduction on every reattempt. In other examples, the discount can be cumulative, such as a 10% discount of the last transaction amount, which amount may have already been discounted during the reattempting process.

In some examples, a target number of reattempts can be set beyond which the interaction is no longer reattempted. For example, the interaction engine can obtain an indication of a target number of reattempts of the interaction. This indication can be retrieved from a memory, received from the source entity, or received from a third party. Next the interaction engine can determine a reattempt number by tracking the number of reattempts. This can comprise maintaining a counter that tracks the number of times a given interaction has been attempted/reattempted. Next, the interaction can be reattempted if the reattempt number or count is less than the target number of reattempts and the interaction has not been previously successfully attempted with the entity.

Furthermore, in some examples the determination of whether to reattempt an interaction can be based on the elapsed time since either the initial or the latest attempt/reattempt of the interaction. In other words, the decision can be based on a target attempt age. In these examples the interaction engine can obtain an indication of a target reattempt age. This can set an age beyond which an interaction is not to be reattempted. Next, the interaction engine can determine an age of a prior attempt of the interaction. The age can be measured in a suitable time interval such as hours, days, weeks, months, and the like. Subsequently, the interaction can be reattempted if the age is less than the target attempt age and the interaction has not been previously successfully attempted with the entity. This can allow the interaction engine to discontinue reattempting of interactions that have become too old.

In some examples, the interaction engine can obtain an indication of the percentage of the unsuccessful interactions associated with a source entity or campaign that are to be reattempted. This percentage can also be referred to as a salvage percentage. When such a percentage has been set, the interaction engine can reattempt unsuccessful interactions until the salvage percentage has been achieved, and then discontinue reattempting for other unsuccessful interactions. In examples where the source entity incurs a cost for reattempting interactions, the salvage percentage can allow the source entity to tailor the balance of reattempting costs with the likely benefits of reattempting interactions. Some examples of costs associated with reattempting can include power costs, computer processing costs, bandwidth and/or network costs, transaction or payment processing costs, and the like.

Moreover, in some examples additional parameters, rules, and/or conditions can be considered in determining whether to reattempt an interaction. For example, the reason for the initial declined or unsuccessful interaction can be considered as such a condition. In the example where the interaction comprises processing a transaction, an additional parameter can comprise the reason for the transaction being declined. For example, if the reason for the decline is insufficient funds, then the transaction can be reattempted later in the event additional funds have been provided since the prior unsuccessful attempt. The decline reasons can be used by the interaction engine as an additional parameter to determine whether to reattempt an interaction such as processing a transaction.

While some of the method steps described herein are indicated as being performed by the interaction engine, it is contemplated that some or all of such steps or functionalities can be performed by engines or modules other than the interaction engine.

Turning now to FIG. 3, a block diagram is shown of the example system 105, which comprises a memory 305 in communication with an interaction engine 310. Memory 305 may include a non-transitory machine-readable storage medium that may be an electronic, magnetic, optical, or other physical storage device that stores executable instructions. The machine-readable storage medium may include, for example, random access memory (RAM), read-only memory (ROM), electrically-erasable programmable read-only memory (EEPROM), flash memory, a storage drive, an optical disc, and the like. The machine-readable storage medium may be encoded with executable instructions. In some example systems, memory 305 may include a database.

Interaction engine 310 may comprise a processor 345, which may include a central processing unit (CPU), a graphics processing unit (GPU), a microcontroller, a microprocessor, a processing core, a field-programmable gate array (FPGA), or similar device capable of executing instructions. In some examples, processor 345 can comprise virtualized processing capability provided by parallel processors or a cloud computing system. Processor 345 can cooperate with the memory 305 to execute instructions.

System 105, and its interaction engine 310 and processor 345, can carry out the functions and processes described in relation to method 200 and the other methods described herein. For example, processor 345 can receive an identifier 315 that is associated with an entity from a set of entities, and stored in memory 305. Processor 345 can further obtain a suitability score 320 for the entity based on identifier 315. Suitability score 320 can be stored in memory 305.

Moreover, processor 345 can receive a selection of an objective 325, which can be associated with suitability score 320. Objective 325 can be stored in memory 305 in association with suitability score 320. In some examples, the formula or equation used to calculate suitability score 320 can be derived or selected based on objective 325. Objective 325, as stored in memory 305, can comprise a description or other indication of an objective such the example objectives described herein.

Furthermore, processor 345 can receive a selection of a suitability tolerance 330 associated with objective 325. Suitability tolerance 330 can also be associated with a suitability score range 335. Suitability tolerance 330 and suitability score range 335 can be stored in memory 305, and in some examples can be stored in association with one another. In addition, processor 345 can generate an acceptability indicator 340 by determining whether suitability score 320 falls within suitability score range 335. Acceptability indicator 340 can indicate whether an interaction is to be attempted with the entity over a communication network. Acceptability indicator 340 can be stored in memory 305. Moreover, processor 345 can output acceptability indicator 340, for example by storing acceptability indicator 340 in memory 305 or another storage inside and/or outside of system 105, by sending acceptability indicator 340 to an output terminal, by sending acceptability indicator 340 to another system, and the like.

In FIG. 3 suitability score 320, objective 325, suitability tolerance 330, suitability score range 335, and acceptability indicator 340 are shown using dashed lines to signify that while these components may be stored in memory 305 of system 105, in some examples one or more of these components may be stored outside system 105 or outside memory 305 in system 105. Furthermore, in some examples, identifier 315 need not be stored in memory 305, and may be stored outside system 105 or outside memory 305 in system 105.

In addition, in some examples memory 305 may be a component in or a part of interaction engine 310. In such examples, system 105 can be functionally equivalent to interaction engine 310. In other examples, system 105 need not comprise a memory and interaction engine 310 can be in communication with a memory external to system 105.

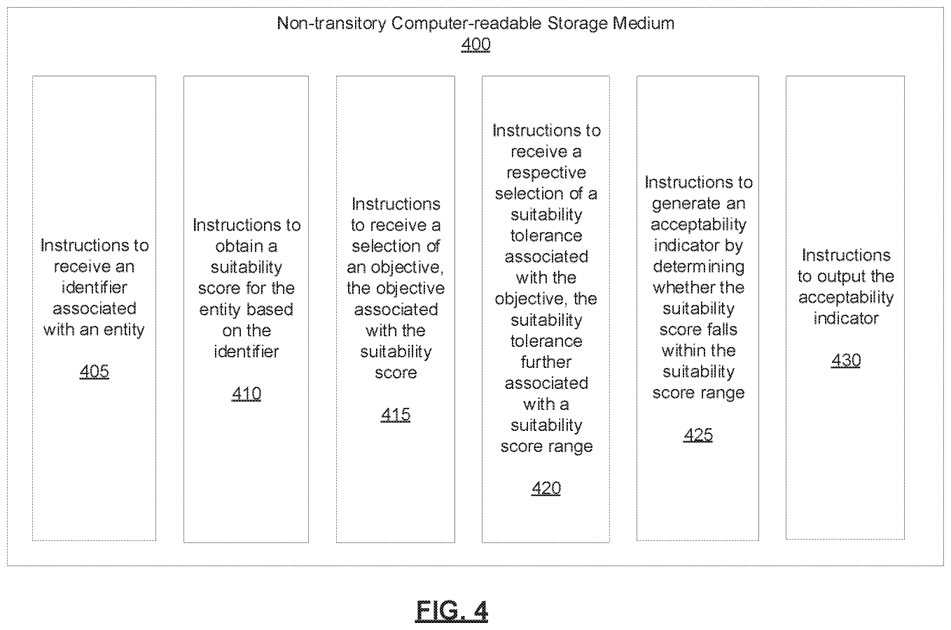

Turning now to FIG. 4, an example non-transitory computer-readable storage medium (CRSM) 400 is shown, which comprises instructions executable by a processor. The CRSM can comprise an electronic, magnetic, optical, or other physical storage device that stores executable instructions. The instructions can comprise instructions 405 to cause the processor to receive an identifier associated with an entity, and instructions 410 to cause the processor to obtain a suitability score for the entity based on the identifier. Moreover, the instructions can comprise instructions 415 to cause the processor to receive a selection of an objective, the objective associated with the suitability score, and instructions 420 to cause the processor to receive a respective selection of a suitability tolerance associated with the objective. The suitability tolerance can be further associated with a suitability score range. Furthermore, the instructions can comprise instructions 425 to cause the processor to generate an acceptability indicator by determining whether the suitability score falls within the suitability score range. The acceptability indicator can indicate whether the interaction is to be attempted with the entity. In addition, the instructions can comprise instructions 430 to cause the processor to output the acceptability indicator.

In some examples, the CRSMs described herein can comprise instructions to cause a processor, interaction engine, and/or system to carry out the functions and processes described in relation to method 200 and the other methods described herein.

In addition, the functions and processes described in relation to method 200 and the other methods described herein can be defined in computer program code or computer program products for the execution of those method steps when the computer program or computer program product is loaded in a computing engine and/or executed by a computing engine. The computing engine can comprise a physical or virtualized computer or computing system.

Moreover, the methods, systems, CRSMs, and computer program products described herein can include the features and/or perform the functions described herein in association with one or a combination of the other methods, systems, CRSMs, and computer program products described herein.

While some of the above examples described herein are in the context of transactions between sellers and buyers, it is contemplated that the features and functionalities described herein in relation to transactions can also apply to other contexts such as IoT and the like. The functions and features described herein can allow a source entity contemplating interacting with a target entity over a communication network to decide whether the target entity is acceptable for the interaction. This determination can be made even if the target entity is remote from and imperfectly known to the source entity. This can reduce the likelihood of the source entity suffering damage or having its systems compromised as a result of interacting with unacceptable target entities.

In addition, if an attempt at the interaction is unsuccessful, the features and functionalities described herein can allow the interaction to be reattempted to increase the likelihood of an eventual successful attempt of the interaction. This can build redundancy and resiliency, and can reduce the likelihood of a hard or final failure of the interaction. This in turn can provide for a communication protocol between the source and target entities (via the interaction engine) which communication protocol is more resilient by virtue of being able to reattempt if there are failed interaction attempts.

The above-described are examples and alterations and modifications may be effected thereto, by those of skill in the art, without departing from the scope of the invention which is defined solely by the claims appended hereto.

1. A method comprising:
receiving at an interaction engine an identifier associated with an entity from a set of entities;
obtaining at the interaction engine a suitability score for the entity based on the identifier;
receiving at the interaction engine a selection of an objective, the objective associated with the suitability score;
receiving at the interaction engine a respective selection of a suitability tolerance associated with the objective, the suitability tolerance further associated with a suitability score range;
generating at the interaction engine an acceptability indicator by determining whether the suitability score falls within the suitability score range, the acceptability indicator to indicate whether an interaction is to be attempted with the entity over a communication network; and
outputting the acceptability indicator.

2. (canceled)

3. The method of claim 1, wherein the obtaining the suitability score comprises generating the suitability score based on past behavior of the entity.

4-5. (canceled)

6. The method of claim 1, wherein the obtaining the suitability score comprises calculating the suitability score based on a formula selected based on the objective.

7-8. (canceled)

9. The method of claim 1, further comprising:
obtaining at the interaction engine a further suitability score for a further entity from the set of entities; and
generating at the interaction engine a further acceptability indicator, the further acceptability indicator being positive regardless of whether the further suitability score falls within the suitability score range.

10. The method of claim 1, further comprising:
obtaining at the interaction engine a reattempt schedule for reattempting the interaction with the entity; and
reattempting the interaction with the entity according to the reattempt schedule if the interaction has not been previously successfully attempted with the entity.

11. (canceled)

12. The method of claim 1, further comprising:
obtaining at the interaction engine a discount indication; and
wherein the reattempting comprises attempting to process a transaction discounted according to the discount indication.

13. The method of claim 1, wherein the reattempt schedule comprises one or more of: frequency, date, time of day, time zone, and day of the week.

14. The method of claim 1, further comprising:
obtaining at the interaction engine an indication of a target number of reattempts of the interaction;
determining at the interaction engine a reattempt number by tracking the number of reattempts; and
reattempting the interaction if the reattempt number is less than the target number of reattempts and the interaction has not been previously successfully attempted with the entity.

15. The method of claim 1, further comprising:
obtaining at the interaction engine an indication of a target attempt age;
determining at the interaction engine an age of a prior attempt of the interaction; and
reattempting the interaction if the age is less than the target attempt age and the interaction has not been previously successfully attempted with the entity.

16. A system comprising;
a memory to store an identifier associated with an entity from a set of entities;
an interaction engine in communication with the memory, the interaction engine comprising a processor to:
receive the identifier;
obtain a suitability score for the entity based on the identifier;
receive a selection of an objective, the objective associated with the suitability score;
receive a respective selection of a suitability tolerance associated with the objective, the suitability tolerance further associated with a suitability score range;
generate an acceptability indicator by determining whether the suitability score falls within the suitability score range, the acceptability indicator configured to indicate whether an interaction is to be attempted with the entity over a communication network; and
output the acceptability indicator.

17. (canceled)

18. The system of claim 16, wherein to obtain the suitability score the processor is to generate the suitability score based on past behavior of the entity.

19-20. (canceled)

21. The system of claim 16, wherein the processor is further to calculate the suitability score based on a formula selected based on the objective.

22-23. (canceled)

24. The system of claim 16, wherein the processor is further to:
obtain a further suitability score for a further entity from the set of entities; and
generate a further acceptability indicator, the further acceptability indicator being positive regardless of whether the further suitability score falls within the suitability score range.

25. The system of claim 16, wherein the processor is further to:
obtain a reattempt schedule for reattempting the interaction with the entity; and
reattempt the interaction with the entity according to the reattempt schedule if the interaction has not been previously successfully attempted with the entity.

26. (canceled)

27. The system of claim 16, the processor is further to:
obtain a discount indication; and
wherein to reattempt the interaction the processor is to attempt to process a transaction discounted according to the discount indication.

28. The system of claim 25, wherein the reattempt schedule comprises one or more of: frequency, date, time of day, time zone, and day of the week.

29. The system of claim 16, wherein the processor is further to:
obtain an indication of a target number of reattempts of the interaction;
determine the reattempt number by tracking the number of reattempts; and
reattempt the interaction if the reattempt number is less than the target number of reattempts and the interaction with the entity has not been previously successfully attempted.

30. The system of claim 16, wherein the processor is further to:
obtain an indication of a target attempt age;
determine an age of a prior attempt of the interaction; and
reattempt the interaction if the age is less than the target attempt age and the interaction with the entity has not been previously successfully attempted.

31. A non-transitory computer-readable storage medium comprising instructions executable by a computing engine, the instructions to cause the computing engine to:
receive at an interaction engine an identifier associated with an entity from a set of entities;
obtain at the interaction engine a suitability score for the entity based on the identifier;
receive at the interaction engine a selection of an objective, the objective associated with the suitability score;
receive at the interaction engine a respective selection of a suitability tolerance associated with the objective, the suitability tolerance further associated with a suitability score range;
generate at the interaction engine an acceptability indicator by determining whether the suitability score falls within the suitability score range, the acceptability indicator to indicate whether an interaction as to be attempted with the entity over a communication network; and
output the acceptability indicator.

32. (canceled)
